(19) United States
(12) Patent Application Publication
(10) Pub. No.: US 2005/0169456 A1
(43) Pub. Date: Aug. 4, 2005

(54) Collect callback

(75) Inventors: Jeffrey B. Smith, Veradale, WA (US); Michael L. Eberle, Vista, CA (US)

Correspondence Address: LEE & HAYES, PLLC, 421 W. RIVERSIDE AVE, STE 500, SPOKANE, WA, 99201, US

(73) Assignee: dX/dY Voice Processing, Inc., Spokane, WA (US)

(21) Appl. No.: 11/087,207

(22) Filed: Mar. 23, 2005

Related U.S. Application Data
(63) Continuation-in-part of application No. 10/672,348, filed on Sep. 26, 2003.

(51) Int. Cl. H04M 3/00

(52) U.S. Cl. 379/265.09

(57) ABSTRACT

Collect callback is described. In an embodiment, a Web site associated with a call-in service provides that a call source can initiate a collect callback option to establish a communication link with the call-in service. A switch receives callback data corresponding to the call source via the Web site and utilizes the callback data to establish a collect call via the communication link between the call source and the call-in service.

### RELATED APPLICATION

This application is a continuation-in-part and claims priority to U.S. patent application Ser. No. 10/672,348 entitled “Collect Callback” filed Sep. 26, 2003 to Smith et al., the disclosure of which is incorporated by reference herein.

This application is also related to a concurrently-filed U.S. patent application Ser. No. ______ (Attorney Docket No. XY1-003US) entitled “Collect Callback for Web-Based Access” to Smith et al., the disclosure of which is incorporated by reference herein.

### TECHNICAL FIELD

This invention relates to collect callback.

### BACKGROUND

Some telephone switching systems provide a callback feature that allows a caller to call the switching system, receive a hang-up response tone or some other indication from the system, and have the switching system call back so that the caller can dial a long distance number, yet maintain a cheaper rate through the switching system. Another caller-initiated callback system enables a caller to submit a callback request via the Internet, such as to a call center, and directly from an HTML page. The call center then completes the call to the number provided by the caller. These and other conventional caller-initiated callback systems are convenient and economical for business travelers and vacationers, for example, that travel overseas yet do not want to pay for the high costs, or tariffs, to place a call through a foreign telecommunications system.

### SUMMARY

Collect callback is described herein.

In an implementation, a Web site associated with a call-in service provides that a call source can initiate a collect callback option to establish a communication link with the call-in service. A switch receives callback data corresponding to the call source via the Web site and utilizes the callback data to establish a collect call via the communication link between the call source and the call-in service.

### BRIEF DESCRIPTION OF THE DRAWINGS

The same numbers are used throughout the drawings to reference like features and components.

FIG. 1 illustrates an exemplary collect callback system.

FIG. 2 illustrates another exemplary collect callback system.

FIG. 3 illustrates examples of data associated with collect callback and maintained with a database as shown in FIG. 2.

FIG. 4 illustrates examples of recorded and associated data maintained with an archive as shown in FIG. 2.

FIG. 5 illustrates an exemplary collect callback system having any number of various components.

FIG. 6 illustrates an exemplary implementation of a collect callback system.

FIG. 7 further illustrates the exemplary implementation of the collect callback system shown in FIG. 6.

FIGS. 8A and 8B illustrate a flow diagram of an exemplary method for collect callback.

FIG. 9 illustrates various components of an exemplary computing device that may be implemented as various components of a collect callback system.

### DETAILED DESCRIPTION

Collect callback is described in which a call-in service establishes a communication link with a caller, or call source (such as via a telephone-based communication link), and initiates a collect callback option for the caller. In an event that a caller accepts the collect callback option, the call-in service communicates callback data to a switch that utilizes the callback data to authorize the collect call for the caller and to establish a collect call via a second communication link between the caller and the call-in service through the switch.

In an alternate embodiment of collect callback, the caller or call source can establish an Internet-based communication link to a Web site that is associated with the call-in service. The caller can initiate a collect callback option via the Web site to establish a collect call with the call-in service. The Web site communicates the callback data to the switch that utilizes the callback data to authorize the collect call for the caller, and to establish the collect call via a telephone-based communication link between the caller and the call-in service through the switch.

Collect callback may be implemented as part of a telecommunications system, a public switched telephone network, or as component(s) of any other communication and/or information services system, such as a Web site via the Internet. While aspects of the described systems and methods for collect callback can be implemented in any of these systems, collect callback is described in the context of the following exemplary environment.

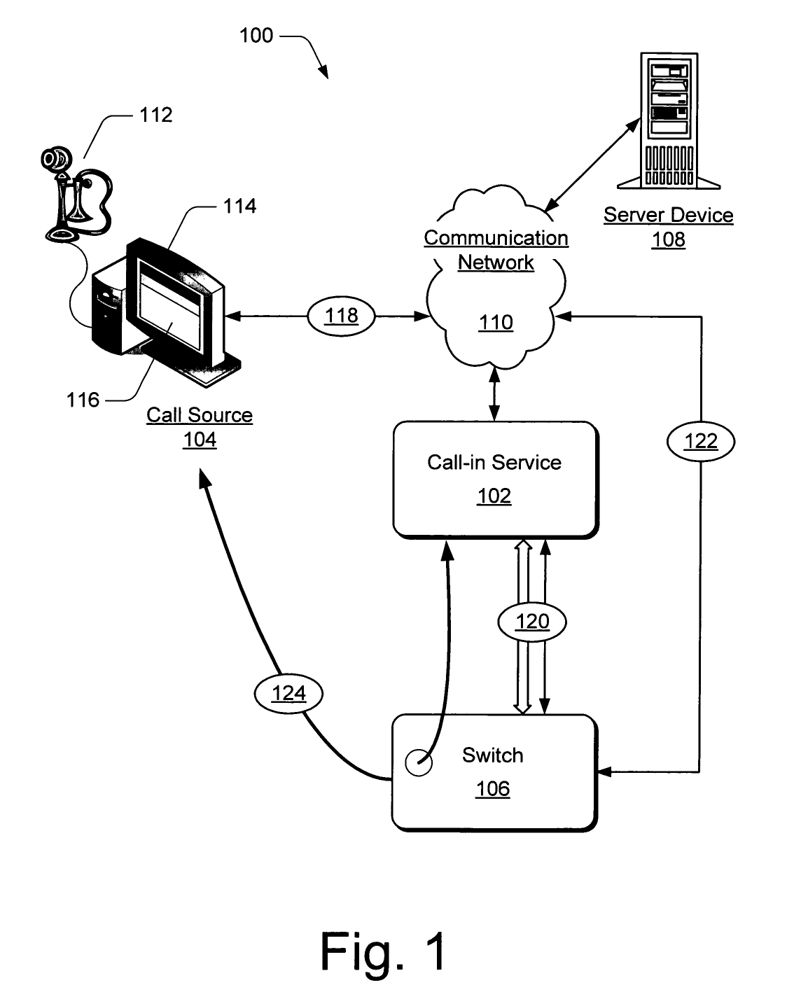

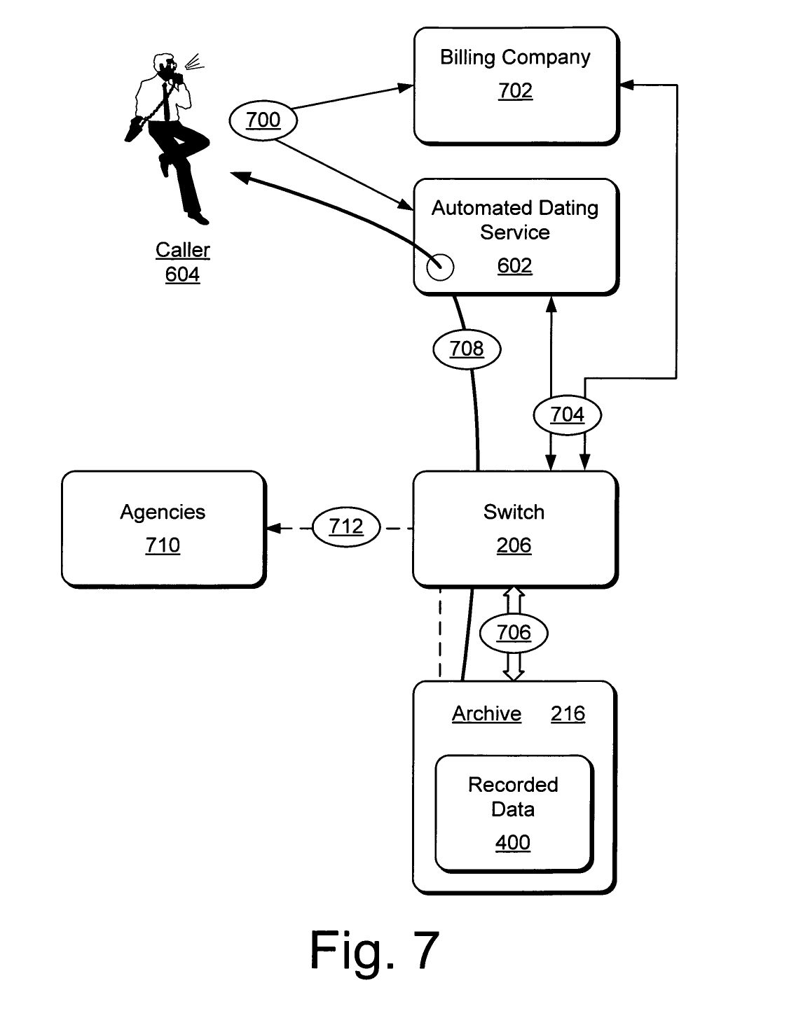

FIG. 1 illustrates an exemplary collect callback system 100 that includes a call-in service 102, a call source 104, a switch 106, and a server device 108 each of which are configured for communication via a communication network 110, such as an intranet or the Internet. The collect callback system 100 can be implemented in any form of telecommunications, communications, and/or information services system to include an Internet-based communication system. Call-in service 102 may be implemented as any number of different call-in and/or automated services that provide a service for a fee, such as an information service, technical support service, research database service, Web site access for a fee, and the like. In one implementation a collect callback system can be implemented as an automated call-in dating service which is described with reference to FIG. 6.

Although the call-in service 102 and the switch 106 are each illustrated and described as independent components of the collect callback system 100, the call-in service 102 can be implemented as an integrated component of the switch 106, and vice-versa. Accordingly, any functionality described herein pertaining to an automated or call-in service and/or pertaining to a switch can be performed by either one or both of the call-in service and the switch as described with reference to the various embodiments of collect callback. Additionally, the server device 108 can implement the call-in service 102, and vice-versa, to implement the various embodiments of collect callback as described herein.

In the example shown in FIG. 1, call source 104 may be a caller (e.g., a person or computer user), a communication device 112 (e.g., a telephone, either wired or wireless), an automated device, any other type of electronic or computing device 114, and/or any combination thereof at a call origin, call station, call location, etc. Although the telephone 112 is illustrated as being communicatively coupled through computing device 114, the telephone 112 may be configured for communication independent of computing device 114. In this example, computing device 114 includes a Web browser application to facilitate user interaction with a Web site 116 that is associated with the call-in service 102 and which is hosted by server device 108 via communication network 110.

When a caller at call source 104 initiates communication with the Web site 116 that is associated with call-in service 102 and hosted by server device 108, an Internet-based communication link 118 is established such that the call source 104 and the server device 108 are communicatively coupled, or connected, either via a wired or wireless connection over communication network 110.

A caller 104 may be enticed via advertising or Web site 116 to call into or otherwise initiate communication with the call-in service 102 for a duration during which the caller is not charged for the call (e.g., via a telephone-based communication link for a call utilizing telephone 112). The call-in service 102 may then offer the caller 104 a number of payment options to continue the call, such as charging the connection time to a credit card, calling a nine-hundred number to which a billing rate applies (e.g., typically on a per-minute basis), or the call-in service 102 can initiate a collect callback option for the caller 104. Similarly, the Web site 116 associated with the call-in service 102 may also offer the same payment options to the caller via the Web site 116.

In an event that a caller at call source 104 selects the collect callback option by stating as such or by touchtone communication via the telephone 112 (e.g., the caller authorizes a collect call as a form of payment to continue the call or service), the call-in service 102 communicates callback data to the switch 106 via any type of communication link 120. In an alternate embodiment, a caller at call source 104 can initiate the collect callback option via the Web site 116 (e.g., by initiating a selectable control option on the user interface) and the callback data is communicated to the switch 106 from Web site 116 via communication link 122.

The call-in service 102, switch 106, server device 108, and computing device 114 may each include a communication interface by which the components are communicatively linked. The communication link(s) 118, 120, 122, and the other communication links described herein with reference to the several collect callback system implementations, can be any one or combination of a serial, parallel, network, wireless, satellite, Internet, or public switched telephone network interface that communicatively couples the components with each other and/or with other electronic or computing devices. Other examples of a communication link implementation can include digital, universal serial bus (USB), local area network (LAN), wide area network (WAN), metropolitan area network (MAN), any form of an Internet Protocol (IP) connection, and other similar types of information and communication connections.

The callback data communicated from call-in service 102, or via Web site 116, to switch 106 includes a call-in service identifier (e.g., any type of number and/or text designator) and a call source identifier (e.g., a ten-digit telephone number corresponding to the call source 104). When the communication link 118 is discontinued, the switch 106 utilizes the call source identifier to initiate and establish the collect call via a telephone-based communication link 124 between the call source 104 (e.g., a caller at telephone 112) and the call-in service 102. In this example, the collect call communication link 124 is routed through the switch 106.

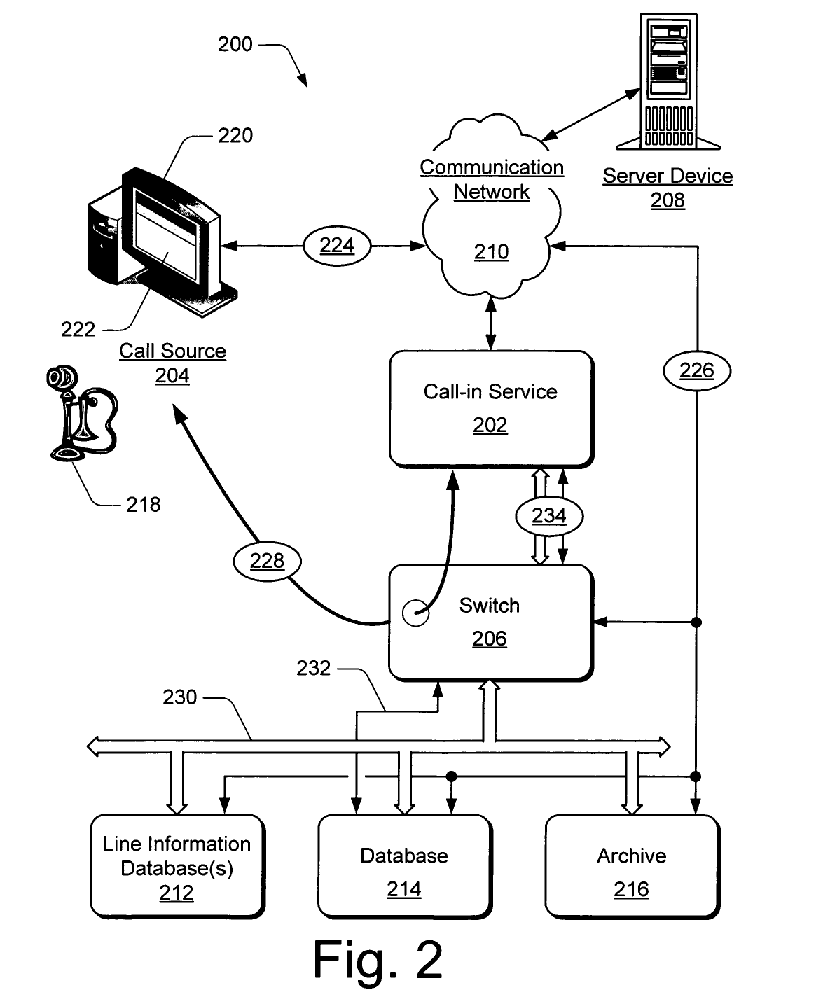

FIG. 2 illustrates an exemplary collect callback system 200 that includes a call-in service 202, a call source 204, a switch 206, and a server device 208 each of which are described above with reference to FIG. 1. The various components of collect callback system 200 are each configured for communication via a communication network 210, such as an intranet or the Internet. The collect callback system 200 may also be implemented in any form of telecommunications, communications, and/or information services system to include an Internet-based communication system. Collect callback system 200 also includes Line Information Database(s) 212, a database 214, and an archive 216.

In this example, call source 204 may be a caller (e.g., a person or computer user), a communication device 218 (e.g., a telephone, either wired or wireless), an automated device, any other type of electronic or computing device 220, and/or any combination thereof at a call origin, call station, call location, etc. Computing device 220 includes a Web browser application to facilitate user interaction with a Web site 222 that is associated with the call-in service 202 and which is hosted by server device 208 via communication network 210.

When a caller at call source 204 initiates communication with the Web site 222 that is associated with call-in service 202 and hosted by server device 208, an Internet-based communication link 224 is established such that the call source 204 and the server device 208 are communicatively coupled, or connected, either via a wired or wireless connection over communication network 210. The Web site 222 initiates a collect callback option for the call source (e.g., a caller and/or computer user) after a time duration of access (e.g., units of minutes) during which the call source may or may not be charged for the call. When call source 204 authorizes a collect call as a form of payment to continue the call or service, the callback data is communicated to switch 206 from Web site 222 via communication link 226.

Switch 206, call-in service 202, and/or server device 208 can query the Line Information Database(s) 212 to verify that the call source 204 can be billed for a collect call before establishing the collect call between the call-in service 202 and the call source 204. The Line Information Database 212 is also commonly referred to as “LIDB” and contains caller information, such as a service profile, name and address, and telephone number validation information. The line information is typically accessed by other service providers to determine how to respond to a call or call request. For example, a service provider (e.g., switch 206) can determine whether to allow call source 204 the collect call, or to block the call.

The callback data communicated from call-in service 202, or via Web site 222, to switch 206 includes a call-in service identifier (e.g., any type of number and/or text designator) and a call source identifier (e.g., a ten-digit telephone number corresponding to the call source 204). The database 214 maintains a table or any other form of a data structure of relational data that includes call-in service identifiers and an associated access code for a particular call-in service 202. In an event that a collect callback system is implemented with one or more switches and multiple call-in services, a switch will obtain an access code for a particular call-in service so that the switch will re-establish a caller's communication link back to the same call-in service that initiated the collect callback option.

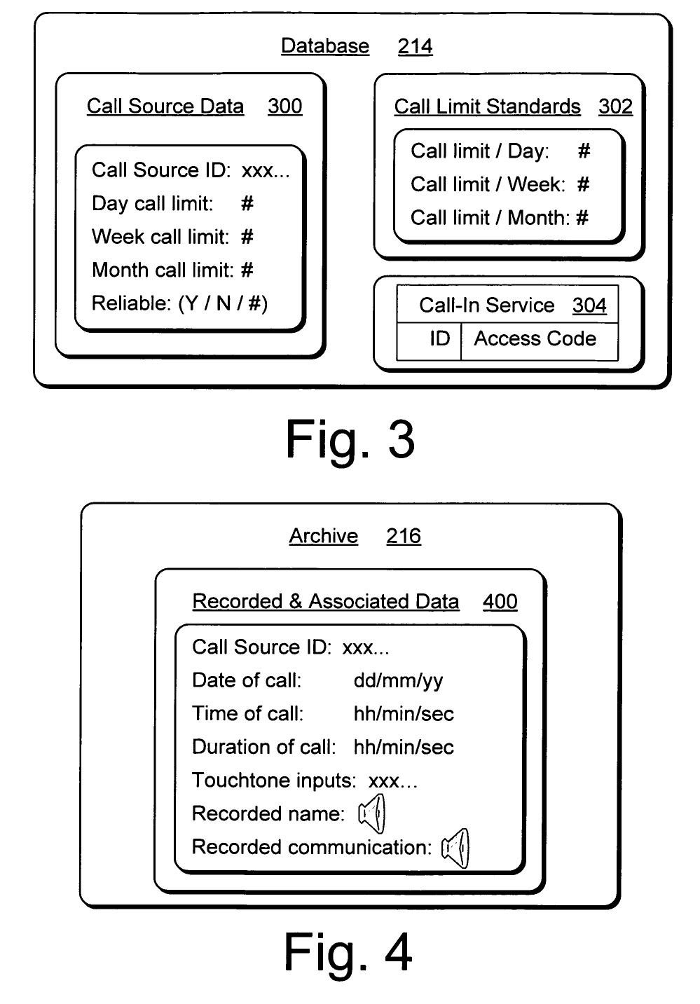

The switch 206 can obtain an access code that corresponds to a call-in service identifier received as callback data, and utilize the call source identifier and the access code to establish the collect call via a telephone-based communication link 228 between the call source 204 and the call-in service 202. The switch 206, call-in service 202, and/or server device 208 can also obtain source data from database 214 that corresponds to the call source 204 to determine whether to authorize the collect call for the call source 204. For example, the call source data includes call limits for the call source which may be compared to call limit standards, also maintained by database 214. The call limits and call limit standards are described further with reference to FIG. 3. The switch 206, call-in service 202, and/or server device 208 can be communicatively coupled to any of the Line Information Database 212, database 214, and/or archive 216 via any number of different communication links 226, 230, and 232 (e.g., as described with reference to the communication links shown in FIG. 1.)

The archive 216 maintains recorded data associated with the collect call. For example, the recorded data can include a recorded name of the call source (e.g., a caller's name) and a recording of the collect call, or a portion of the collect call. The switch 206 can communicate an instruction (e.g., via communication link 228) to the call source 204 to verbalize a name to generate the recorded name of the call source (e.g., the name of the caller and/or computer user on telephone 218).

After verifying and authorizing the collect call, switch 206 can notify the call-in service 202 via communication link(s) 234 that the collect call for the call source 204 is authorized. The switch 206 can then establish the collect call via the telephone-based communication link 228 between call source 204 and the call-in service 202 through switch 206. After establishing the collect call communication link 228, the switch 206 can transfer communications, or portions thereof, of the collect call to the archive 216 to generate the recording of the collect call, or a recording of a portion of the collect call.

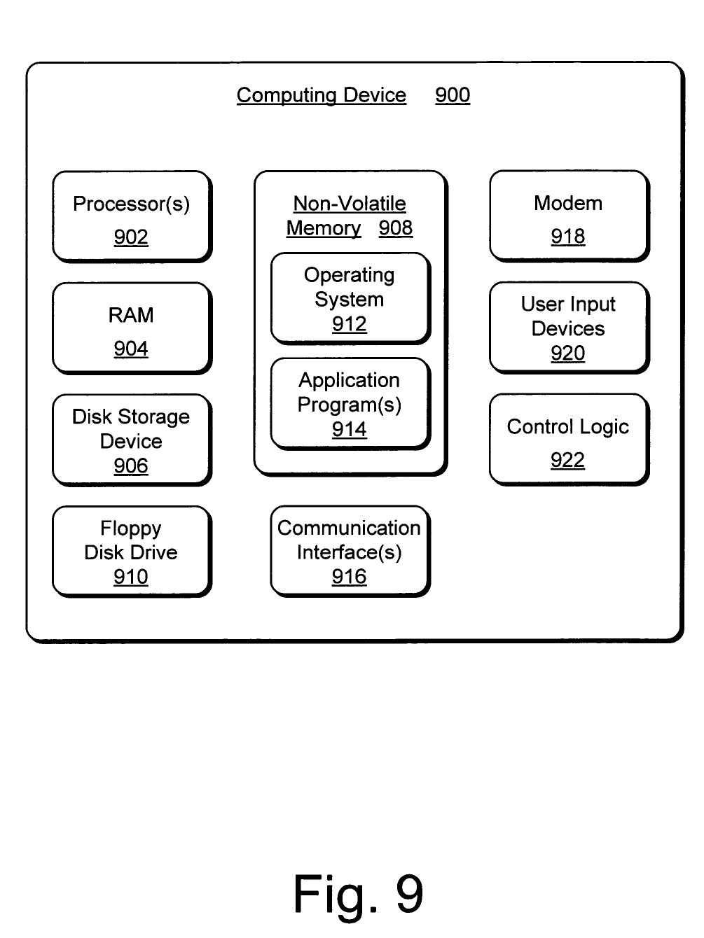

Although database 214 and archive 216 are each illustrated and described as single database implementations, each of the database 214 and the archive 216 can be implemented as several memory components distributed to each maintain data and information pertaining to collect callback in any embodiment of a collect callback system as described herein. Further, although database 214 and archive 216 are each illustrated and described as separate databases, the database 214 and the archive 216 can be implemented together as a single database. Additionally, the database 214 and archive 216 can each be implemented as a memory component of the switch 206. Although not shown in this example, any of the components of a collect callback system (e.g., collect callback systems 100 and 200), such as switch 206, may be implemented with any number and combination of differing components as further described below with reference to the exemplary computing device 900 shown in FIG. 9.

FIG. 3 illustrates examples of data associated with collect callback and maintained with a database 214 as shown in FIG. 2. Call source data 300 corresponds to a call source (e.g., call sources 104 and 204) and can include a call source identifier, a day call limit, a week call limit, month call limit, and an indication of whether the call source is reliable in paying for collect call charges in a timely manner. Any and/or all of the call source data 300 can be obtained by switch 206, call-in service 202, and/or server device 208 to determine whether to authorize a collect call for a particular call source 204.

The database 214 may also maintain call limit standards 302 and a table 304 (e.g., any form of a data structure) of relational data that includes a call-in service identifier and an associated access code for a particular call-in service 202. The call limit standards 302 can be based on established thresholds as determined by uncollected revenue and/or based on the averages of all callers that do not pay for telephone charges, such as long distance charges, collect call charges, etc. One example of call limit standards 302 can be two calls per day that are only twenty minutes each, eighty minutes per week, and one-hundred twenty minutes per month.

The call limits in the call source data 300 for a particular call source 204 can be based on these call limit standards 302, or can be adjusted on a caller by caller basis. For example, the indication of whether a call source is reliable (e.g., “yes”, “no”, and/or some number or text indicator to rate a call source) can be utilized to increase or decrease a particular call source day, week, and month call limits. Optionally, a call source can be blocked from making any calls through the switch due to a poor payment history.

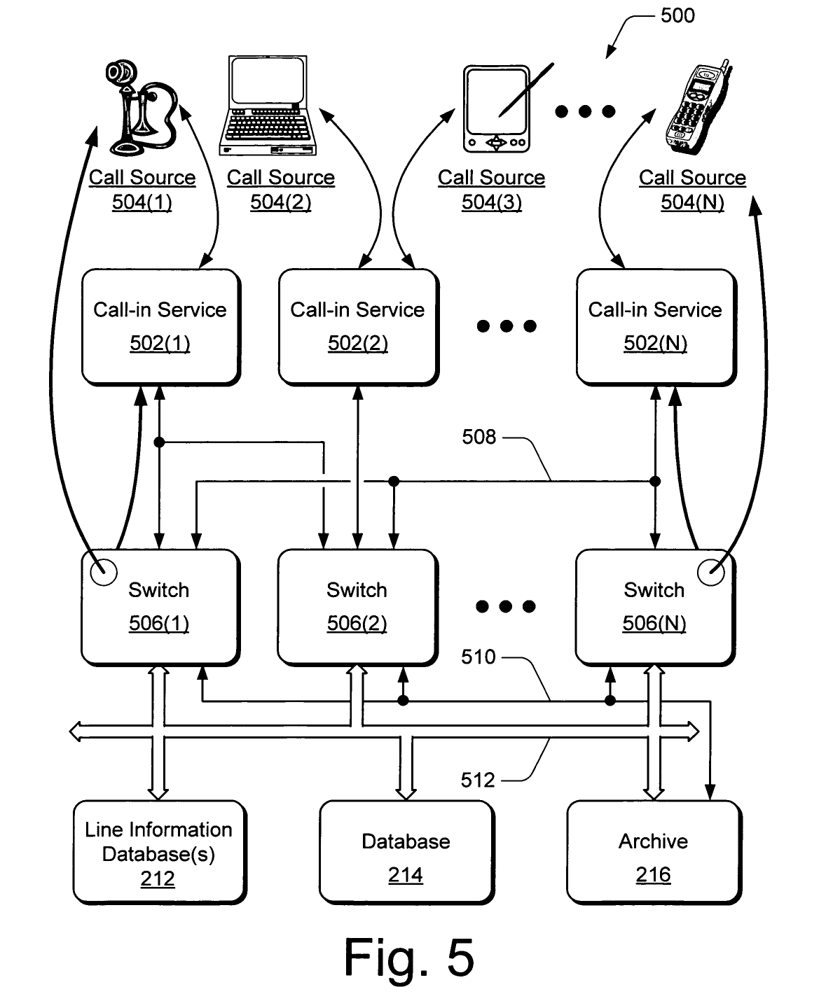

FIG. 4 illustrates an example of recorded and associated data 400 that is maintained in archive 216 and which corresponds to a collect call. The recorded and associated data 400 includes any one or combination of a call source identifier associated with the collect call, a date of the collect call, a time of the collect call, a duration of the collect call, any caller touchtone inputs, a recorded name of a caller, and a recording of the collect call, or a portion thereof.

The switch 206 can obtain any of this archived and recorded information corresponding to a particular collect call when a caller disputes the charges for the collect call. For example, when a caller calls into a telephone billing company to dispute the charges for a collect call, the caller can be communicatively linked to the recorded and associated data 400 where they will hear themselves identified (e.g., recorded name) and at least a portion of the collect call (e.g., recorded communication). Although database 214 is shown with only one example of call source data 300 for only one call source 204, and archive 216 is shown with only one example of recorded and associated data 400 for a single collect call, each can maintain any number of call source data and recorded data, respectively, that corresponds to any number of call sources and associated collect calls.

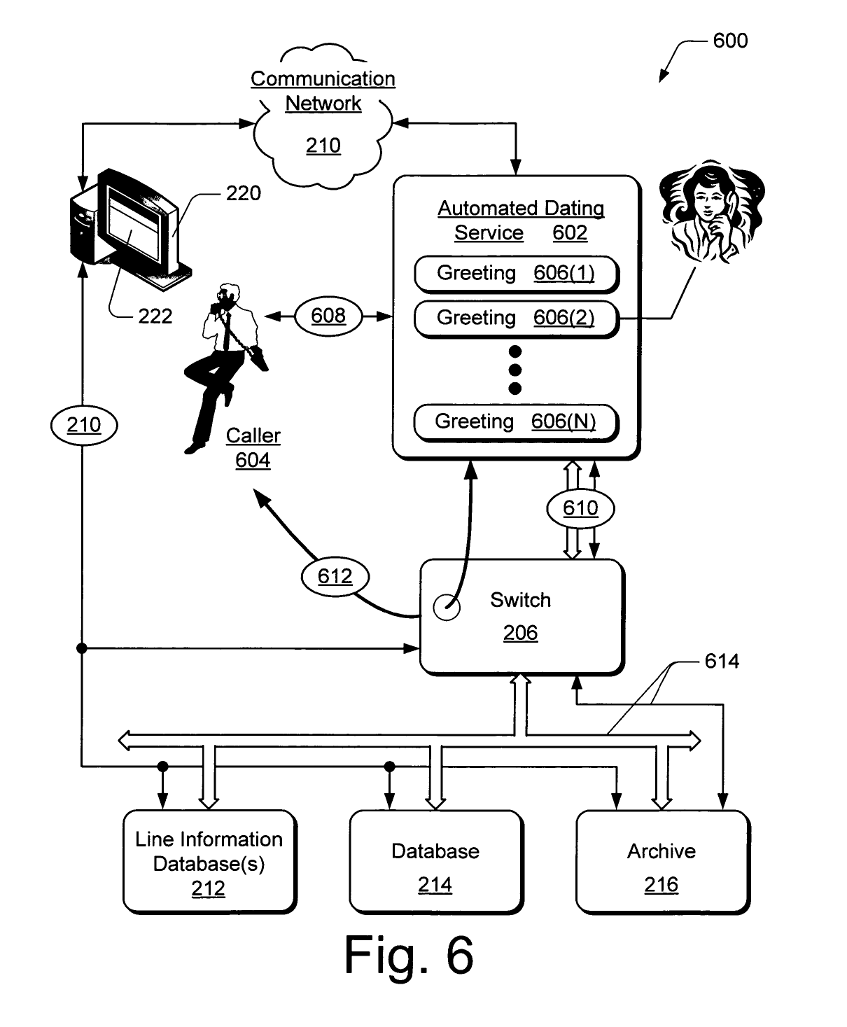

FIG. 5 illustrates an exemplary collect callback system 500 having any number of various components such as multiple call-in services 502(1-N), multiple call sources 504(1-N), and multiple switch components 506(1-N). A call source 504 can be any wired or wireless communication device such as any one or combination of a phone 504(1), a portable computer 504(2), a PDA 504(3), a cell phone 504(N), and/or any other electronic or computing device. Call source 504(2) is an example of a computing device (e.g., call source computing device 114 or call source computing device 220) that includes a Web browser application to facilitate user interaction with a Web site that is associated with a call-in service 502, and via which a collect callback option can be initiated by a user of the computer 504(2).

Any number of the call sources 504 can be communicatively linked to a call-in service 502 at any one time. For example, call sources 504(2) and 504(3) are each in communication with call-in service 502(2). Further, any number of the call-in services 502 can be communicatively linked to a switch component 506 at any one time via communication links 508. For example, call-in services 502(1), 502(2), and 502(N) are all in communication with switch 506(2). Additionally, each switch 506 can access the Line Information Database(s) 212, the database 214, and the archive 216 via communication links 510 and 512.

FIG. 6 illustrates an exemplary implementation of a collect callback system 600 which includes an automated dating service 602, a caller 604, and switch 206. Collect callback system 600 also includes Line Information Database(s) 212, the database 214, and the archive 216 as described above with reference to FIGS. 2-4. Additionally, the collect callback system 600 includes a call source implemented as computing device 220 which facilitates user interaction with a Web site 222 that is associated with the automated dating service 602 and which is hosted by server device 208 (not shown in FIG. 6) via communication network 210, as described above with reference to FIG. 2.

The automated dating service 602 includes multiple recorded greetings 606(1-N) that a caller 604 can access and listen to via a telephone-based communication link 608 or via communication network 210. In this exemplary implementation, women may call into the dating service 602 free of charge and record a greeting 606. Men are enticed to call into the dating service 602 for a duration of time during which the caller 604 may or may not be charged for the call. The caller 604 can listen to the greetings 606 and select any of them to leave a return message for the person that recorded the message. Further, if a caller 604 selects a greeting that has been recorded by someone that is also connected into the service 602, the service can connect the caller and the other person, such as caller 604 and the woman that recorded greeting 606(2).

When the caller's free time or purchased time has been expended, the dating service 602 offers the caller 604 a number of payment options to continue the call, such as charging the connection time to a credit card, calling a nine-hundred number to which a billing rate applies (e.g., typically on a per-minute basis), or the dating service 602 initiates a collect callback option for the caller 604.

In an event that a caller 604 selects the collect callback option by stating as such or by touchtone communication via a telephone (e.g., the caller authorizes a collect call as a form of payment to continue the call or service), the dating service 602 communicates callback data to the switch 206 via any type of communication link 610. Switch 206 can query the Line Information Database(s) 212 to verify that the caller 604 can be billed for a collect call before establishing the collect call between the dating service 602 and the caller 604. The callback data received from the dating service 602 includes a dating service identifier (e.g., call-in service identifier and access code 304 shown in FIG. 3) and a call source identifier (e.g., a ten-digit telephone number corresponding to the caller 604). In an alternate embodiment, the caller 604 can initiate the collect callback option via the Web site 222 associated with the dating service 602 (e.g., by initiating a selectable control option on the user interface at computing device 220 via a Web browser and Web site 222) and the callback data is communicated to the switch 206 from the Web site via communication network 610.

The switch 206 can obtain an access code that corresponds to the dating service identifier and utilize the call source identifier and the access code to establish the collect call via communication link 612 between the caller 604 and the dating service 602. The switch 206 can also obtain caller data (e.g., call source data 300 shown in FIG. 3) via any type of communication links 614 from database 214 that corresponds to the caller 604 to determine whether to authorize the collect call for the caller.

After verifying and authorizing the collect call, switch 206 can notify the dating service 602 via communication link(s) 610 that the collect call for the caller 604 is authorized. The dating service 602 can then discontinue the communication link 608 with the caller 604 so that switch 206 can establish the collect call via the communication link 612 between caller 604 and the dating service 602 through switch 206. The switch can also communicate an instruction (e.g., via communication link 612) to the caller 604 to verbalize his name which is used to generate a recorded name that can be maintained in the archive 216 as recorded data (e.g., recorded and associated data 400 shown in FIG. 4). After establishing the collect call communication link 612, the switch 206 can transfer communications, or portions thereof, of the collect call to the archive 216 to generate a recording of the collect call. In an exemplary embodiment, the first sixty seconds of the collect call are recorded and/or only the caller 604 is recorded.

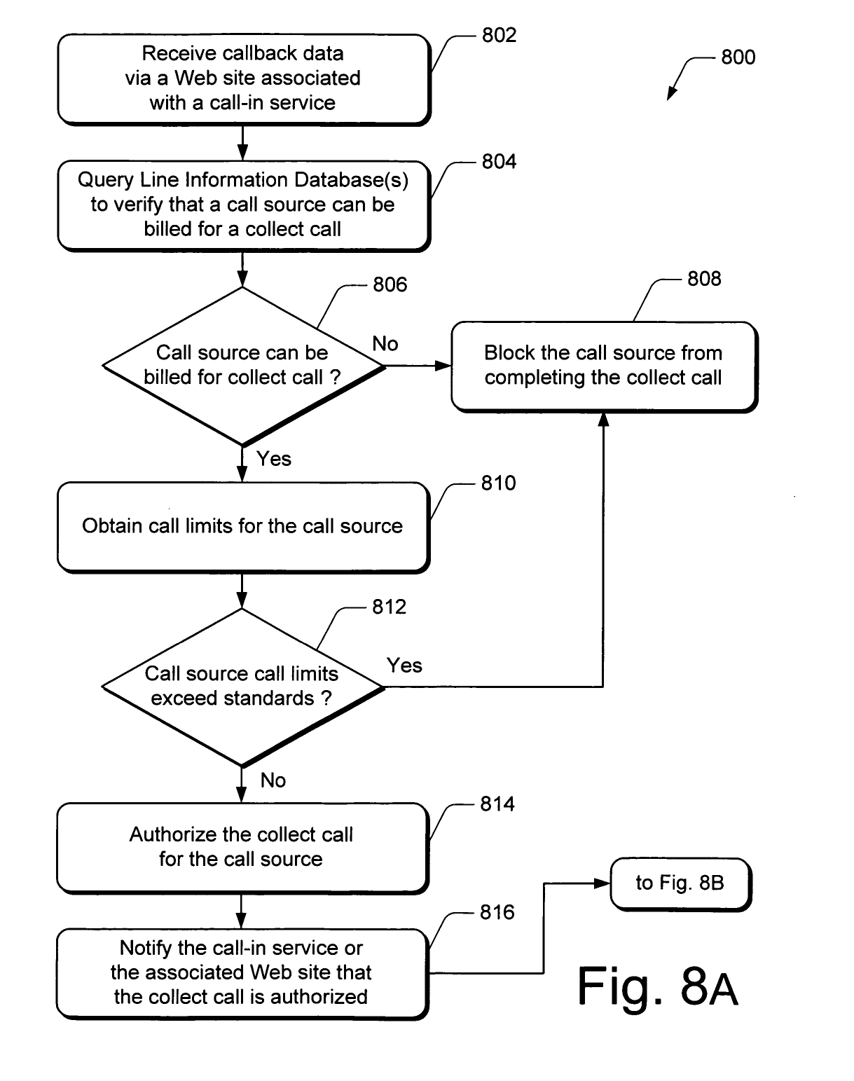

FIG. 7 further illustrates the exemplary implementation of the collect callback system 600 shown in FIG. 6. In this example, caller 604 receives a bill for the collect call to the dating service 602 and calls 700 the billing entity to dispute the charges for the collect call. The billing entity may be the switch 206, the dating service 602, a different billing company 702, and/or any combination thereof which may include a combination of billing entities or companies that cooperate to bill the caller 604 for collect calls. The caller can enter an identifier, or combination of identifiers, for the collect call to identify the disputed call to the billing entity. For example, the caller may enter by touchtone or verbally communicate a tracking number or a combination of the date and time of the collect call (e.g., identifiers or information included on or with the bill).

The billing entity then accesses the archive 216 via communication links 704 and 706 through the switch 206 (e.g., or the switch 206 accesses the archive 216 directly if the switch is the billing entity or is the device used to access the archive). The switch 206 establishes a playback communication link 708 to the caller 604 and from the recorded data 400 that corresponds to the disputed collect call. The caller 604 will hear his own identification (e.g., recorded name) and a portion of the collect call (e.g., recorded communication). The playback communication link 708 can be routed through the billing entity, such as through dating service 602 as shown in FIG. 7. The caller's own identification and recorded portion of the collect call is more than sufficient to sustain the charges against the caller 604.

In an alternate implementation, the switch 206 can obtain the recorded data 400 from archive 216 and submit the recorded data to other agencies (or agency) 710 via a communication link 712 through the switch 206. The recorded data can be submitted as an attached audio file to an email, for example. This may be useful for police investigations, legal challenges, and for any other similar situation in which it is desirable to evidence that a particular caller was a party to a communication on a particular date for a recorded duration of time and/or that the caller authorized payment for a call.

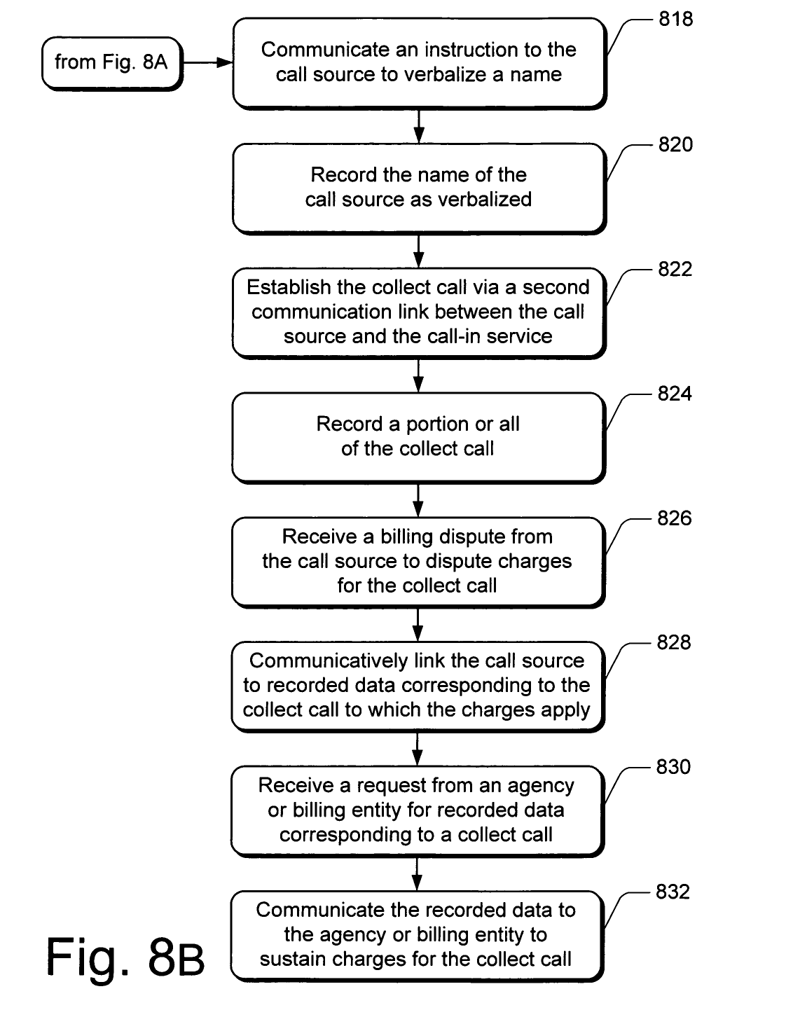

Methods for collect callback, such as exemplary method 800 described with reference to FIGS. 8A and 8B, may be described in the general context of computer-executable instructions. Generally, computer-executable instructions include routines, programs, objects, components, data structures, and the like that perform particular functions or implement particular abstract data types. Methods for collect callback may also be practiced in distributed computing environments where functions are performed by remote processing devices that are linked through a communications network. In a distributed computing environment, computer-executable instructions may be located in both local and remote computer storage media, including memory storage devices.

FIGS. 8A and 8B illustrate a method 800 for collect callback. The order in which the method is described is not intended to be construed as a limitation, and any number of the described method blocks can be combined in any order to implement the method. Furthermore, the method can be implemented in any suitable hardware, software, firmware, or combination thereof.

At block 802 (FIG. 8A), callback data is received via a Web-based service or from a Web site associated with a call-in service. The call-in service or associated Web site receives a collect callback selection from a call source to which the call-in service or associated Web site has initiated a collect callback option via a communication link. For example, Web site 222 hosted by server device 208 (FIG. 2) has an Internet-based communication link 224 with computing device 220 of the call source 204, and the Web site 222 initiates a collect callback option for the call source 204. The call source 204 authorizes, or otherwise selects the collect callback option, and the callback data is communicated to switch 206 via Web site 222. Receiving the callback data includes receiving a call source identifier and a call-in service identifier that corresponds to an associated access code for the call-in service 202.

At block 804, a Line Information Database is queried to verify that a call source can be billed for a collect call and at block 806, a determination is made as to whether the call source can be billed for the collect call. The switch 206, call-in service 202, and/or the server device 208 can query the Line Information Database 212 to determine whether the call source 204 can be billed for the collect call. If the call source cannot be billed for the collect call (i.e., “no” from block 806), then the call source is blocked from completing the collect call at block 808. If the call source can be billed for the collect call (i.e., “yes” from block 806), then call limits for the call source are obtained at block 810. For example, switch 206, call-in service 202, and/or the server device 208 obtains call limits from the call source data 300 (FIG. 3) maintained with database 214.

At block 812, a determination is made as to whether the call limits for the call source exceed call limit standards. For example, switch 206 compares the call limits 300 for the call source to call limit standards 302 also maintained with database 214. The call limit standards 302 include at least one of a day limit, a week limit, and a month limit for calls by a particular call source. If the call limits for the call source do exceed call limit standards (i.e., “yes” from block 812), then the call source is again blocked from completing the collect call at block 808. If the call limits for the call source do not exceed call limit standards (i.e., “no” from block 812), then the collect call is authorized for the call source at block 814.

At block 816, the call-in service or associated Web site is notified that the collect call for the call source is authorized. For example, the switch 206 notifies the call-in service 202 or the Web site 222 (e.g., at the server device 208) that the collect call for the call source 204 is authorized. At block 818 (FIG. 8B), an instruction is communicated to the call source to verbalize a name. For example, switch 206 communicates an instruction via communication link 228 to the call source 204 to verbalize a name (to be recorded). At block 820, the name of the call source is recorded as verbalized. For example, the recorded name of the caller is maintained with the recorded and associated data 400 in archive 216 (FIG. 4).

At block 822, the collect call is established via a telephone-based communication link between the call source and the call-in service. For example, the switch 206 establishes the collect call via communication link 228 between call source 204 and call-in service 202 through the switch 206. At block 824, a portion (or all) of the collect call is recorded. For example, a recorded communication of the collect call is maintained with the recorded and associated data 400 in archive 216 (FIG. 4). The recorded and associated data 400 maintained with archive 216 also includes at least one of a call source identifier, a date of the collect call, a time of the collect call, a duration of the collect call, and/or call source touchtone inputs.

At block 826, a billing dispute is received from the call source to dispute charges for the collect call to the call-in service. For example, a caller 604 (FIG. 7) calls a billing entity (e.g., switch 206, automated dating service 602, or billing company 702) to dispute the charges for a collect call to an automated service 602. At block 828, the call source is communicatively linked to an archive of recorded data corresponding to the collect call to which the charges apply. For example, switch 206 establishes a communication link 708 (FIG. 7) between the archive 216 and the caller 604 such that the caller can listen to the recorded data 400 which includes the caller's recorded name and a recording of a portion of the collect call.

At block 830, a request is received from an agency or billing entity for recorded data corresponding to the collect call. The recorded data can include the recorded name of the call source and the recording of the portion of the collect call. For example, an agency 710 (FIG. 7) can request the recorded data 400 from switch 206. At block 832, the recorded data is communicated to the agency or billing entity such that the agency or billing entity can utilize the recorded data to sustain charges for a collect call. For example, switch 206 communicates the recorded data 400 to an agency 710 via communication link 712.

FIG. 9 illustrates an exemplary computing device 900 that may be implemented as any one of the various components of a collect callback system, such as a switch (e.g., switches 106, 206, and 506), a database 214 and archive 216, a call-in or automated service (e.g., call-in services 102, 202, 502, and 602), and as a call source (e.g., call sources 104, 204, 504, and 604). Computing device 900 includes one or more processors 902 (e.g., any of microprocessors, controllers, and the like) which process various instructions to control the operation of computing device 900 and to communicate with other electronic and computing devices. Computing device 900 can be implemented with one or more memory components, examples of which include a random access memory (RAM) 904, a disk storage device 906, non-volatile memory 908 (e.g., any one or more of a read-only memory (ROM), flash memory, EPROM, EEPROM, etc.), and a floppy disk drive 910.

Disk storage device 906 can include any type of magnetic or optical storage device, such as a hard disk drive, a magnetic tape, a recordable and/or rewriteable compact disc (CD), a DVD, DVD+RW, and the like. The one or more memory components provide data storage mechanisms to store various information and/or data such as configuration information for computing device 900, and any other types of information and data related to operational aspects of computing device 900. Alternative implementations of computing device 900 can include a range of processing and memory capabilities, and may include any number of differing memory components than those illustrated in FIG. 9.

An operating system 912 and one or more application program(s) 914 can be stored in non-volatile memory 908 and executed on processor(s) 902 to provide a runtime environment for computing device 900. An application program 914 can include a Web browser application to facilitate user interaction via the Internet. Computing device 900 further includes one or more communication interfaces 916 and a modem 918. The communication interfaces 916 can be implemented as any one or more of a serial and/or parallel interface, as a wireless interface, any type of network interface, and as any other type of communication interface. A wireless interface enables computing device 900 to receive control input commands and other information from an input device, such as from a remote control device or from another infrared (1R), 802.11, Bluetooth, or similar RF input device.

A network interface provides a connection between computing device 900 and a data communication network which allows other electronic and computing devices coupled to a common data communication network to communicate information to computing device 900 via the network. Similarly, a serial and/or parallel interface provides a data communication path directly between computing device 900 and another electronic or computing device. Modem 918 facilitates computing device 900 communication with other electronic and computing devices via a conventional telephone line, a DSL connection, cable, and/or via other types of connections.

Computing device 900 may include user input devices 920 that can include a keyboard, mouse, pointing device, and/or other mechanisms to interact with, and to input information to computing device 900. Computing device 900 also may include control logic 922. As used herein, the term “logic” refers to hardware, firmware, software, or any combination thereof that may be implemented to perform the logical operations associated with a particular function or with the operability of computing device 900, a switch (e.g., switch 206), a database (e.g., database 210 and archive 212), or a call source (e.g., phone 218 or computing device 220). Logic may also include any supporting circuitry that is utilized to complete a given task including supportive non-logical operations. For example, logic may also include analog circuitry, memory components, input/output (I/O) circuitry, interface circuitry, and the like.

Although shown separately, some of the components of computing device 900 may be implemented in an application specific integrated circuit (ASIC). Additionally, a system bus (not shown) typically connects the various components within computing device 900. A system bus can be implemented as one or more of any of several types of bus structures, including a memory bus or memory controller, a peripheral bus, an accelerated graphics port, or a local bus using any of a variety of bus architectures.

Although collect callback has been described in language specific to structural features and/or methods, it is to be understood that the subject of the appended claims is not necessarily limited to the specific features or methods described. Rather, the specific features and methods are disclosed as exemplary implementations of collect callback.

1. A collect callback system, comprising:
a Web site via which a call source can initiate a collect callback option to establish a communication link with a call-in service that is associated with the Web site; and
a switch configured to receive callback data corresponding to the call source via the Web site, the switch further configured to establish a collect call via the communication link between the call source and the call-in service.

2. A collect callback system as recited in claim 1, wherein the switch is further configured to route the collect call between the call source and the call-in service through the switch.

3. A collect callback system as recited in claim 1, wherein the call-in service is implemented as a component of the switch.

4. A collect callback system as recited in claim 1, wherein the switch is further configured to notify the call-in service that the collect call for the call source is authorized.

5. A collect callback system as recited in claim 1, wherein the switch is further configured to query a Line Information Database to verify that the call source can be billed for the collect call.

6. A collect callback system as recited in claim 1, further comprising a database configured to maintain call source data that corresponds to the call source, and wherein the switch is further configured to obtain the call source data from the database and authorize the collect call for the call source.

7. A collect callback system as recited in claim 1, further comprising a database configured to maintain a call-in service identifier and an associated access code that each correspond to the call-in service, and wherein the switch is further configured to:
receive the callback data which includes the call-in service identifier and a call source identifier;
obtain the access code associated with the call-in service identifier from the database; and
utilize the call source identifier and the access code to establish the collect call between the call source and the call-in service.

8. A collect callback system as recited in claim 1, further comprising a database configured to:
maintain call source data that corresponds to the call source, the call source data including call limits for the call source;
maintain call limit standards that identify at least one of a day limit, a week limit, or a month limit; and
wherein the switch is further configured to obtain the call source data from the database and authorize the collect call for the call source if the call limits for the call source do not exceed the call limit standards.

9. A collect callback system as recited in claim 1, further comprising a database configured to maintain an archive of recorded data associated with the collect call between the call source and the call-in service, the recorded data including a recorded name of the call source and a recording of at least a portion of the collect call;
wherein the switch is further configured to:
communicate an instruction to the call source to verbalize a name to generate the recorded name of the call source; and
transfer at least a portion of the collect call to the database to generate the recording of the collect call.

10. A collect callback system as recited in claim 1, further comprising a database configured to maintain an archive of recorded data associated with the collect call between the call source and the call-in service, the recorded data including at least one of a call source identifier, a date of the collect call, a time of the collect call, a duration of the collect call, call source touchtone inputs, a recorded name of the call source, or a recording of at least a portion of the collect call;
wherein the switch is further configured to:
communicate an instruction to the call source to verbalize a name to generate the recorded name of the call source; and
transfer at least a portion of the collect call to the database to generate the recording of the collect call.

11. A collect callback system as recited in claim 1, further comprising a database configured to:
maintain call source data that corresponds to the call source, the call source data including call limits for the call source;
maintain call limit standards that identify at least one of a day limit, a week limit, or a month limit;
maintain an archive of recorded data associated with the collect call between the call source and the call-in service, the recorded data including a recorded name of the call source and a recording of at least a portion of the collect call;
wherein the switch is further configured to:
query a Line Information Database to verify that the call source can be billed for the collect call;
obtain the call source data from the database and authorize the collect call for the call source if the call limits for the call source do not exceed the call limit standards;
communicate an instruction to the call source to verbalize a name to generate the recorded name of the call source; and
transfer at least a portion of the collect call to the database to generate the recording of the collect call.

12. A telecommunications system comprising the collect callback system as recited in claim 1.

13. A collect callback system, comprising:
a switch configured to receive callback data via a Web site that is associated with a call-in service, the callback data corresponding to a call source that initiates a collect callback option via the Web site, the switch further configured to establish a collect call via a communication link between the call source and the call-in service;
a database configured to maintain an archive of recorded data associated with the collect call between the call source and the call-in service, the recorded data including a recorded name of the call source and a recording of at least a portion of the collect call;
the switch further configured to:
communicate an instruction to the call source to verbalize a name to generate the recorded name of the call source; and
transfer at least the portion of the collect call to the database to generate the recording of the collect call.

14. A collect callback system as recited in claim 13, wherein the call-in service and the database are implemented as components of the switch.

15. A collect callback system as recited in claim 13, wherein the switch is further configured to route the collect call between the call source and the call-in service through the switch.

16. A collect callback system as recited in claim 13, wherein the database is further configured to maintain associated recorded data that includes at least one of a call source identifier, a date of the collect call, a time of the collect call, a duration of the collect call, or call source touchtone inputs.

17. A collect callback system as recited in claim 13, wherein the switch is further configured to notify the call-in service that the collect call for the call source is authorized.

18. A collect callback system as recited in claim 13, wherein the switch is further configured to query a Line Information Database to verify that the call source can be billed for the collect call.

19. A collect callback system as recited in claim 13, wherein the database is further configured to maintain call source data that corresponds to the call source, and wherein the switch is further configured to obtain the call source data from the database and authorize the collect call for the call source.

20. A collect callback system as recited in claim 13, wherein the database is further configured to maintain a call-in service identifier and an associated access code that each correspond to the call-in service, and wherein the switch is further configured to:
receive the callback data which includes the call-in service identifier and a call source identifier;
obtain the access code associated with the call-in service identifier from the database; and
utilize the call source identifier and the access code to establish the collect call between the call source and the call-in service.

21. A collect callback system as recited in claim 13, wherein the database is further configured to:
maintain call source data that corresponds to the call source, the call source data including call limits for the call source;
maintain call limit standards that identify at least one of a day limit, a week limit, or a month limit; and
wherein the switch is further configured to obtain the call source data from the database and authorize the collect call for the call source if the call limits for the call source do not exceed the call limit standards.

22. A telecommunications system comprising the collect callback system as recited in claim 13.

23. A collect callback system comprising a switch configured to:
receive callback data that includes a call-in service identifier and a call source identifier via a Web site associated with a call-in service, the callback data corresponding to a call source that initiates a collect callback option via the Web site;
utilize the call source identifier to initiate a collect call for the call source;
communicate an instruction to the call source to verbalize a name to generate a recorded name of the call source;
utilize the call-in service identifier to establish the collect call via a communication link between the call source and the call-in service; and
generate a recording of at least a portion of the collect call.

24. A collect callback system, comprising:
an automated service having an associated Web site configured to (1) establish an Internet-based communication link with a caller, (2) receive a collect callback option initiated by the caller as a form of payment for a duration of a collect call, and (3) receive an authorization input for the collect call from the caller;
a database configured to maintain an archive of recorded data associated with the collect call, the recorded data including a recorded name of the caller and a recording of at least a portion of the collect call; and
a switch configured to (1) receive callback data via the Web site, (2) communicate an instruction to the caller to verbalize a name to generate the recorded name, (3) establish the collect call via a telephone-based communication link between the caller and the automated service, and (4) transfer the collect call to the database to generate the recording of the collect call.

25. A collect callback system as recited in claim 24, wherein the switch is further configured to route the collect call via the telephone-based communication link through the switch.

26. A collect callback system as recited in claim 24, wherein the database is further configured to maintain associated recorded data that includes at least one of a caller identifier, a date of the collect call, a time of the collect call, a duration of the collect call, or caller touchtone inputs.

27. A collect callback system as recited in claim 24, wherein the switch is further configured to notify the automated service that the collect call for the caller is authorized.

28. A collect callback system as recited in claim 24, wherein the database is further configured to maintain caller data that corresponds to the caller, and wherein the switch is further configured to:
query a Line Information Database to verify that the caller can be billed for the collect call;
obtain the caller data from the database; and
authorize the collect call for the caller.

29. A collect callback system as recited in claim 24, wherein the database is further configured to maintain a service identifier and an associated access code that each correspond to the automated service, and wherein the switch is further configured to:
receive the callback data which includes the service identifier and a caller identifier;
obtain the access code associated with the service identifier from the database; and
utilize the caller identifier and the access code to establish the collect call via the telephone-based communication link between the caller and the automated service.

30. A collect callback system as recited in claim 24, wherein the database is further configured to:
maintain caller data that corresponds to the caller, the caller data including call limits for the caller;
maintain call limit standards that identify at least one of a day limit, a week limit, or a month limit; and
wherein the switch is further configured to obtain the caller data from the database and authorize the collect call for the caller if the call limits for the caller do not exceed the call limit standards.

31. A collect callback system as recited in claim 24, further comprising a billing entity configured to:
bill the caller for the collect call;
receive a billing dispute from the caller that disputes charges for the collect call to the automated service;
communicatively link the caller to the archive of recorded data associated with the collect call to which the charges apply; and
playback the recorded name of the caller and the recording of the collect call to the caller such that the charges for the collect call can be sustained.

32. A telecommunications system comprising the collect callback system as recited in claim 24.

33. A method for collect callback, comprising:
receiving callback data via a Web site that is associated with a call-in service, the callback data corresponding to a call source that initiates a collect callback option via the Web site;
establishing a first communication link to the call source;
communicating an instruction to the call source to verbalize a name;
recording the name of the call source;
establishing a collect call via a second communication link between the call source and the call-in service; and
recording at least a portion of the collect call.

34. A method for collect callback as recited in claim 33, further comprising maintaining recorded data that includes at least one of the recording of the call source name, the recording of the collect call, a call source identifier, a date of the collect call, a time of the collect call, a duration of the collect call, or call source touchtone inputs.

35. A method for collect callback as recited in claim 33, further comprising notifying the call-in service that the collect call for the call source is authorized.

36. A method for collect callback as recited in claim 33, further comprising querying a Line Information Database to verify that the call source can be billed for the collect call.

37. A method for collect callback as recited in claim 33, wherein receiving the callback data includes receiving a call source identifier and a call-in service identifier that corresponds to an associated access code for the call-in service.

38. A method for collect callback as recited in claim 33, further comprising:
obtaining call limits for the call source; and
authorizing the collect call for the call source if the call limits for the call source do not exceed call limit standards that identify at least one of a day limit, a week limit, or a month limit.

39. A method for collect callback as recited in claim 33, further comprising:
receiving a billing dispute from the call source that disputes charges for the collect call to the call-in service;
communicatively linking the call source to an archive of recorded data corresponding to the collect call to which the charges apply, the recorded data including the recording of the call source name and the recording of the collect call.

40. A method for collect callback as recited in claim 33, further comprising:
receiving a request from a billing entity for recorded data corresponding to the collect call, the recorded data including the recording of the call source name and the recording of the collect call; and
communicating the recorded data to the billing entity such that the billing entity can utilize the recorded data to sustain the charges for the collect call.

41. A method for collect callback, comprising:
establishing an Internet-based communication link between a caller and a Web site associated with an automated service;
initiating a collect callback option for the caller as a form of payment for a duration of a collect call to the automated service;
receiving via the Web site an authorization input for the collect call from the caller;
maintaining an archive of recorded data associated with the collect call, the recorded data including a recording of at least a portion of the collect call;
establishing the collect call via a telephone-based communication link between the caller and the automated service; and
recording the portion of the collect call.

42. A method for collect callback as recited in claim 41, further comprising communicating an instruction to the caller to verbalize a name to generate a recorded name of the caller that is maintained in the archive as additional recorded data associated with the collect call.

43. A method for collect callback as recited in claim 41, further comprising maintaining associated recorded data that includes at least one of a caller identifier, a date of the collect call, a time of the collect call, a duration of the collect call, or caller touchtone inputs.

44. A method for collect callback as recited in claim 41, further comprising notifying the automated service that the collect call for the caller is authorized.

45. A method for collect callback as recited in claim 41, further comprising querying a Line Information Database to verify that the caller can be billed for the collect call.

46. A method for collect callback as recited in claim 41, further comprising:
maintaining caller data that corresponds to the caller, the caller data including call limits for the caller;
maintaining call limit standards that identify at least one of a day limit, a week limit, or a month limit; and
authorizing the collect call for the caller if the call limits for the caller do not exceed the call limit standards.

47. A method for collect callback as recited in claim 41, comprising:
receiving a billing dispute from the caller to dispute charges for the collect call to the automated service;
communicatively linking the caller to the archive of recorded data associated with the collect call to which the charges apply; and
playing back the recorded name of the caller and the recording of the collect call to the caller such that the charges for the collect call can be sustained.

48. One or more computer-readable media comprising computer executable instructions that, when executed, direct a telecommunications switch to:
receive callback data via a Web site that receives a collect callback selection from a caller, the Web site being associated with a service;
communicate an instruction to the caller to verbalize a name;
record the name of the caller;
establish a collect call via a communication link between the caller and the service; and
record at least a portion of the collect call.

49. One or more computer-readable media as recited in claim 48, further comprising computer executable instructions that, when executed, direct the telecommunications switch to notify the service that the collect call for the caller is authorized.

50. One or more computer-readable media as recited in claim 48, further comprising computer executable instructions that, when executed, direct the telecommunications switch to query a Line Information Database to verify that the caller can be billed for the collect call.

51. One or more computer-readable media as recited in claim 48, further comprising computer executable instructions that, when executed, direct the telecommunications switch to:
obtain call limits for the caller; and
authorize the collect call for the caller if the call limits for the caller do not exceed call limit standards that identify at least one of a day limit, a week limit, or a month limit.

52. A collect callback system, comprising an automated call-in device configured to:
establish an Internet-based communication link with a call source that initiates communication with the automated call-in device;
initiate a collect callback option for the call source;
receive an authorization input for collect call payment from the call source; and
establish a collect call for the call source via a telephone-based communication link.

53. A collect callback system as recited in claim 52, wherein the automated call-in device is further configured to query a Line Information Database to verify that the call source can be billed for the collect call.

54. A collect callback system as recited in claim 52, wherein the automated call-in device is an integrated component of a telecommunications switch.

55. A collect callback system as recited in claim 52, wherein the automated call-in device is further configured to obtain call source data from a database and authorize the collect call for the call source.

56. A collect callback system as recited in claim 52, wherein the automated call-in device is further configured to establish the collect call between the call source and a call-in service.

57. A collect callback system as recited in claim 52, wherein the automated call-in device is further configured to record the authorization input for the collect call payment.

58. A method for collect callback, comprising:
establishing an Internet-based communication link with a call source that initiates communication;
initiating a collect callback option for the call source;
receiving an authorization input for collect call payment from the call source; and
establishing a collect call for the call source via a telephone-based communication link.

59. A method for collect callback as recited in claim 58, further comprising querying a Line Information Database to verify that the call source can be billed for the collect call.

60. A method for collect callback as recited in claim 58, further comprising communicating collect callback data to a telecommunications switch that establishes the collect call for the call source, the collect callback data including a call source identifier and a call-in device identifier.

61. A method for collect callback as recited in claim 58, further comprising communicating collect callback data to a telecommunications switch that establishes the collect call via the telephone-based communication link between the call source and a call-in service.

62. A method for collect callback as recited in claim 58, further comprising obtaining call source data from a database to authorize the collect call for the call source.

63. A method for collect callback as recited in claim 58, further comprising recording the authorization input for the collect call payment.
